(19) United States
(12) Patent Application Publication
(10) Pub. No.: US 2017/0038878 A1
(43) Pub. Date: Feb. 9, 2017

(54) TOUCH PANEL WITH PRESSURE SENSING FUNCTION

(71) Applicant: Chih-Chung Lin, Taipei City (TW)

(72) Inventor: Chih-Chung Lin, Taipei City (TW)

(21) Appl. No.: 14/820,561

(22) Filed: Aug. 7, 2015

(51) Int. Cl. G06F 3/041

(52) U.S. Cl. CPC G06F 3/0414

(57) ABSTRACT

A touch panel with pressure sensing function includes a substrate, a shielding layer, an electrode layer, a pressure-sensing layer, and an optical clear adhesive (OCA) layer. The substrate has a first and an opposite second side. The first side defines a touch zone and a non-touch zone, which is located adjacent to the touch zone to surround a periphery of the touch zone. The shielding layer is located on the second side of the substrate corresponding to the non-touch zone. The electrode layer is disposed on the second side of the substrate, and has a plurality of first and second electrodes, and a plurality of metal conductors, to which the first and second electrodes are electrically connected. The optical clear adhesive layer is covered on the electrode layer; and the pressure-sensing layer is located corresponding to the non-touch zone.

### FIELD OF THE INVENTION

The present invention relates to a touch panel, and more specifically, to a touch panel with pressure sensing function.

### BACKGROUND OF THE INVENTION

The currently available touch panels can generally be divided into two types, namely, resistive and capacitive touch panels. A user's touch and press are required to operate the resistive touch panel, so it has lower sensitivity than that of the capacitive touch panel. However, the capacitive touch panel still has its own disadvantages. For example, the capacitive touch panel does not respond to a touch through a gloved or a wet hand and can only determine a touched position from its X-axis and Y-axis coordinates without the capability of sensing the strength of touch. This means the currently available capacitive touch panel does not provide the function of opening second- and third-level menus to meet the users' increasing requirements for simpler, easier and faster human-computer interaction. Therefore, many human-computer interaction applications have been developed to satisfy the users' requirements.

Currently, users' gestures are used to perform many functions on the capacitive touch panel. However, the current capacitive touch panel is not able to sense or detect pressure, i.e. the strength of the user's touch, meaning the user still needs to operate the capacitive touch panel through touching and pressing.

If the pressure-sensing function can be integrated into the touch panel, so that touching and pressing on the touch panel can provide the same function as clicking the right key on a mouse, it is possible to create a unique and powerful tool for users in doing office work or playing games on the touch panel. This change will bring users completely new experiences in using the touch panel and largely increase the touch panel's competing ability in the PC market.

It is therefore tried by the inventor to develop an improved touch panel with pressure sensing function to overcome the drawbacks and problems in the conventional touch panels.

### SUMMARY OF THE INVENTION

To solve the above problems, a primary object of the present invention is to provide a touch panel with pressure sensing function that has a pressure-sensing layer integrated thereinto.

To achieve the above and other objects, the touch panel according to the present invention includes a substrate, a shielding layer, an electrode layer, an optical clear adhesive (OCA) layer, and a pressure-sensing layer. The substrate has a first and an opposite second side respectively forming an upper and a lower side thereof. The first side defines a touch zone and a non-touch zone, which is located adjacent to the touch zone to surround a periphery of the touch zone. The shielding layer is located on the second side of the substrate corresponding to the non-touch zone. The electrode layer is disposed on the second side of the substrate, and has a plurality of first and second electrodes, and a plurality of metal conductors, to which the first and second electrodes are electrically connected. The optical clear adhesive layer is covered on the electrode layer; and the pressure-sensing layer is located corresponding to the non-touch zone.

By integrating the pressure-sensing layer into the touch panel, the touch panel provides users with functions available not only through conventionally known gestures, but also through different touch strength.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a touch panel with pressure sensing function according to a first preferred embodiment of the present invention;

FIG. 2 is a fragmentary, assembled sectional view of the touch panel with pressure sensing function according to the first preferred embodiment of the present invention;

FIG. 3 is a fragmentary, assembled sectional view of the touch panel with pressure sensing function according to a second preferred embodiment of the present invention;

FIG. 4 is a fragmentary, assembled sectional view of the touch panel with pressure sensing function according to a third preferred embodiment of the present invention;

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

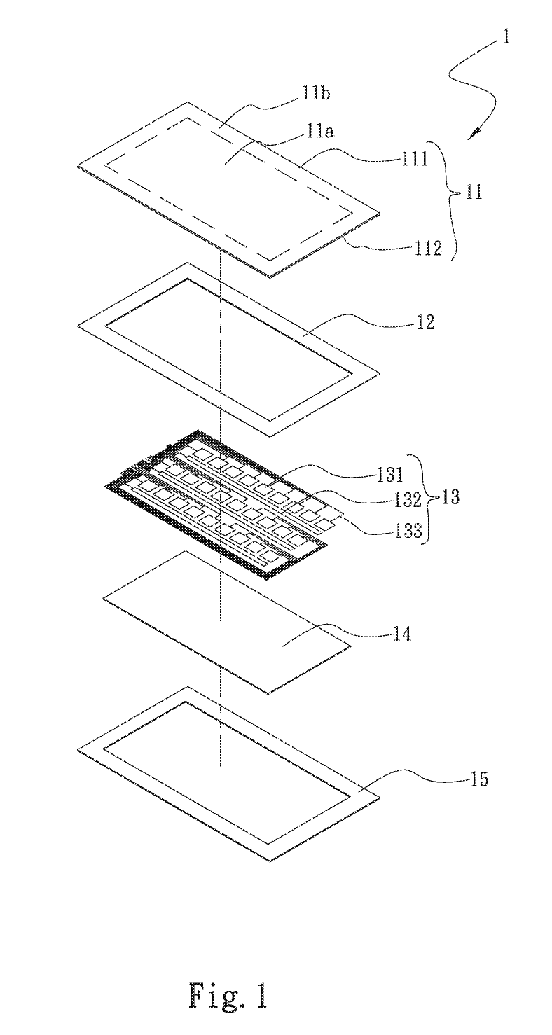

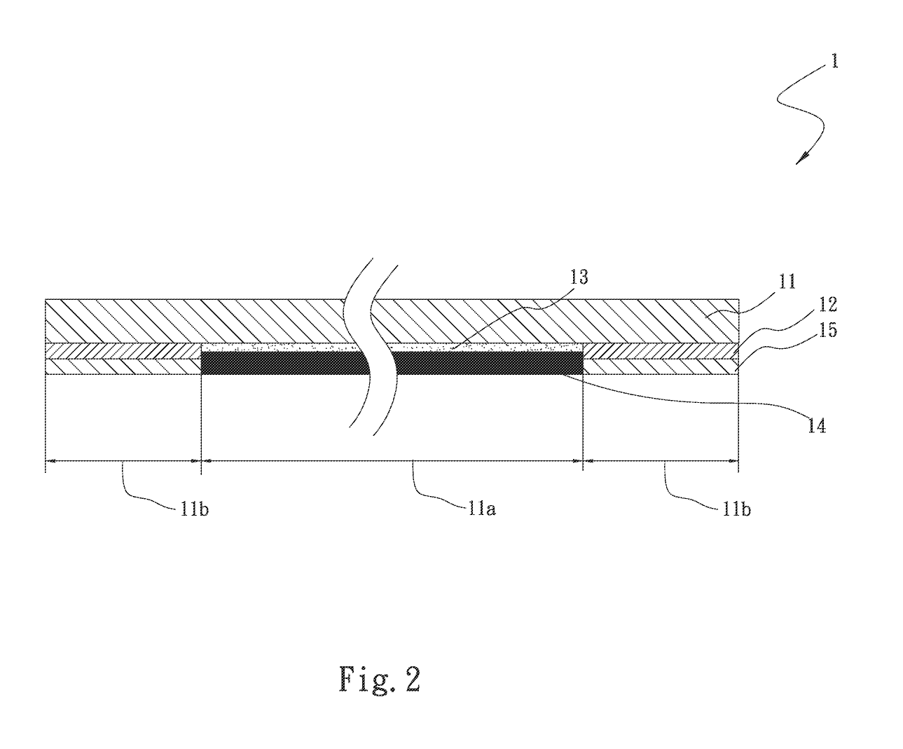

Please refer to FIG. 1, which is an exploded perspective view of a touch panel with pressure sensing function according to a first preferred embodiment of the present invention, and to FIG. 2, which is a fragmentary, assembled sectional view of the touch panel of FIG. 1. For the purpose of conciseness, the present invention is also briefly referred to as the touch panel. As shown, the touch module 1 includes a substrate 11, a shielding layer 12, an electrode layer 13, an optical clear adhesive (OCA) layer 14, and a pressure-sensing layer 15.

The substrate 11 is made of a glass material or a Polyethylene Terephthalate (PET) material, and has a first and an opposite second side 111, 112 respectively forming an upper and a lower side thereof. The first side 111 defines a touch zone 11a and a non-touch zone 11b, which is located adjacent to the touch zone 11a to surround a periphery of the touch zone 11a

The shielding layer 12 is located on the second side 112 of the substrate 11 corresponding to the non-touch zone 11b to surround a periphery of the touch zone 11a.

The electrode layer 13 is disposed on the second side 112 of the substrate 11, and has a plurality of first and second electrodes 131, 132 and a plurality of metal conductors 133, to which the first and second electrodes 131, 132 are electrically connected. The first and the second electrodes 131, 132 and the metal conductors 133 are located adjacent to one another, while the first and the second electrodes 131, 132 are not connected to one another.

The pressure-sensing layer 15 is located corresponding to the non-touch zone 11b and parallel to the electrode layer 13. In the illustrated first embodiment, the pressure-sensing layer 15 is located on one side of the shielding layer 12 opposite to the substrate 11 and is located corresponding to the non-touch zone 11b. The first and the second electrodes 131, 132 are located corresponding to the touch zone 11a, and the pressure-sensing layer 15 and the optical clear adhesive layer 14 are horizontally disposed on the same plane.

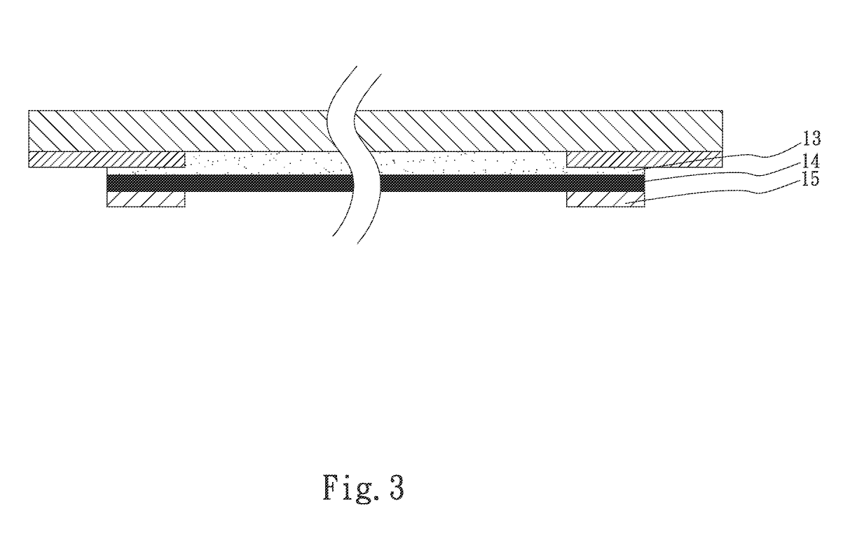

Please refer to FIG. 3, which is a fragmentary, assembled sectional view of the touch panel 1 according to a second preferred embodiment of the present invention. As shown, the second embodiment of the touch panel 1 is generally structurally similar to the first embodiment except that, in the second embodiment, the pressure-sensing layer 15 is located on one side of the optical clear adhesive layer 14 opposite to the electrode layer 13.

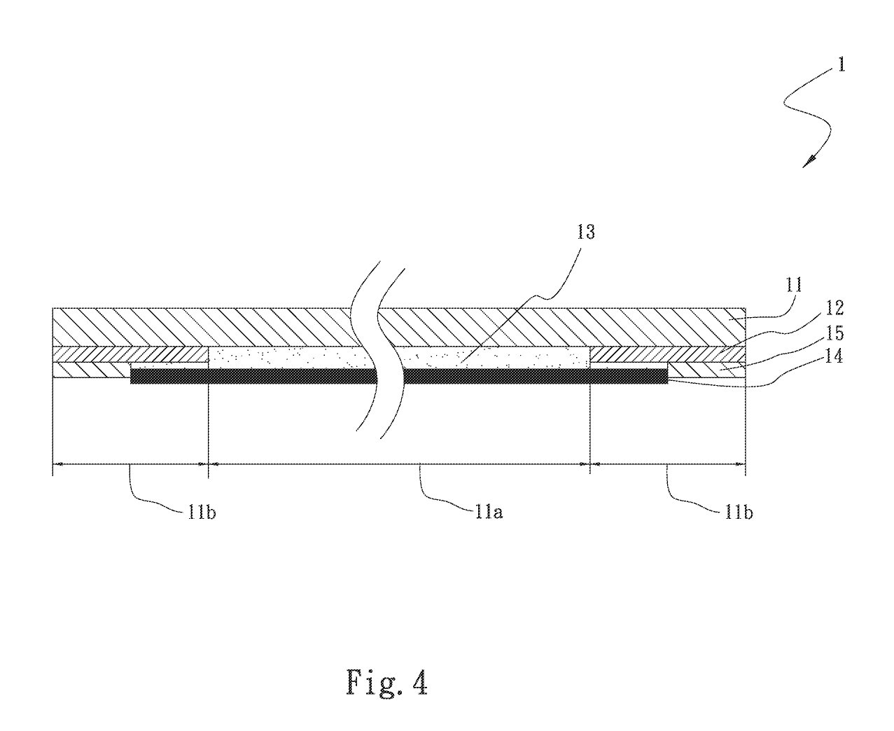

Please refer to FIG. 4, which is a fragmentary, assembled sectional view of the touch panel 1 according to a third preferred embodiment of the present invention. As shown, the third embodiment of the touch panel 1 is generally structurally similar to the first embodiment except that, in the third embodiment, a part of the electrode layer 13 and the pressure-sensing layer 15 are located below the shielding layer 12 corresponding to the non-touch zone 11b. The pressure-sensing layer 15 and the electrode layer 13 are horizontally disposed on the same plane. The optical clear adhesive layer 14 is covered on one side of the electrode layer 13 opposite to the substrate 11.

By integrating the pressure-sensing layer into a big-sized touch panel of a mobile phone, a user can control the mobile phone with only one finger to zoom in and out a picture or a window, or adjust the volume on the touch panel, making the touch panel more convenient for use and operable in more than one touch manner. In addition, the user may also utilize the pressure-sensing function to change the thickness of a line or a stroke when drawing or writing, so as to make the drawing or handwriting more legible.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A touch panel with pressure sensing function, comprising:
a substrate having a first side and an opposite second side respectively forming an upper and a lower side thereof; and the first side defining a touch and a non-touch zone, and the non-touch zone being locate adjacent to the touch zone;
a shielding layer being located on the second side of the substrate corresponding to the non-touch zone;
an electrode layer being disposed on the second side of the substrate and having a plurality of first and second electrodes and a plurality of metal conductors, to which the first and the second electrodes being electrically connected;
an optical clear adhesive layer being covered on the electrode layer; and
a pressure-sensing layer being located corresponding to the non-touch zone.

2. The touch panel as claimed in claim 1, wherein the pressure-sensing layer is located on one side of the shielding layer opposite to the substrate and parallel to the electrode layer.

3. The touch panel as claimed in claim 1, wherein the pressure-sensing layer is located on one side of the optical clear adhesive layer opposite to the electrode layer.

4. The touch panel as claimed in claim 1, wherein the non-touch zone is located around a periphery of the touch zone.

5. The touch panel as claimed in claim 1, wherein the pressure-sensing layer and the optical clear adhesive layer are horizontally disposed on the same plane.

6. The touch panel as claimed in claim 1, wherein the substrate is made of a material selected from the group consisting of a glass material and a Polyethylene Terephthalate (PET) material.
